(19) United States
(12) Patent Application Publication
(10) Pub. No.: US 2002/0129182 A1
(43) Pub. Date: Sep. 12, 2002

(54) Distributed lock management chip

(75) Inventor: Aedan Diarmuid Cailean Coffey, Kilkenny (IE)

Correspondence Address: OPPEDAHL AND LARSON LLP, P O BOX 5068, DILLON, CO, 80435-5068, US

(73) Assignee: Richmount Computers Limited, Dublin (IE)

(21) Appl. No.: 09/683,175

(22) Filed: Nov. 29, 2001

(30) Foreign Application Priority Data
Mar. 8, 2001 (IE) S2001/0224
Jun. 27, 2001 (IE) S2001/0611

(51) Int. Cl. G06F 13/00

(52) U.S. Cl. 710/200

(57) ABSTRACT

A lock management apparatus comprises a PCI socket for receiving from a processor associated with the lock management apparatus an indicator of a resource to be locked. The apparatus causes a corresponding indicator to be stored in a CAM and causes a stored indicator to be deleted when an associated resource is unlocked. The apparatus receives from a FC-AL interface, a frame indicative of a lock request for a resource. If the lock request frame originates from another processor, the apparatus checks any stored indicators for a matching locked resource. If the apparatus detects a match, it transmits a frame indicative of the locked resource to the originator of the lock request; and if it does not detect a match, it transmits the lock request frame to the originator of the lock request.

### BACKGROUND OF INVENTION

The present invention relates to a method for redundant, scaleable, distributed, lock management using the fibre channel loops.

Growth in data-intensive applications such as e-business and multimedia systems has increased the demand for shared and highly available data. A Storage Area Network (SAN) is a switched network developed to deal with such demands and to provide scalable growth and system performance. A SAN typically comprises servers and storage devices connected via peripheral channels such as Fibre Channel (FC) and Small Computer Systems Interface (SCSI), providing fast and reliable access to data amongst the connected devices. FIG. 1 shows a simple example of a SAN (10) comprising two servers (Server A (20) and Server B (30)) connected by a FC-AL (40) to a series of disks (50) configured as a redundant array of independent disks (RAID). The SAN (10) is in turn connected through Server A (20) and Server B (30) to a series of client workstations (60) via a network (70) (e.g. Ethernet/Internet). Server A (20) and Server B (30) are themselves in further communication through a private connection (80) which is not accessible by the client workstations (60) and whose purpose is to facilitate server resetting.

Referring now to FIG. 2 where the components of Server B 30 relevant to the present specification are shown in more detail. The server includes a PCI Bus 230 via which the main components of the server intercommunicate. A CPU 180 communicates with the PCI Bus 230 via a North Bridge controller 200 which also provides access for the CPU to system memory 190 and the PCI Bus. A fibre channel interface chip 220, decodes incoming fibre channel information and communicates this across the PCI bus, for example, by using direct memory access (DMA) to write information into system memory 190 via the North Bridge 200. Similarly, information is written to the chip 220 for encoding and transmission across the fibre channel 40. A network adaptor 160 allows the CPU to process requests received from clients 60 across the network 70, perhaps requiring the CPU 180 in turn to make fibre channel requests for data stored on the disks 50. In the present example, the server includes a dedicated reset controller and watchdog circuit 300, for example, Dallas Semiconductor DS705. On the one hand, the reset controller 300 monitors the state of the CPU and if it decides the CPU has hung, it will automatically reset the entire server by asserting a system-reset signal, which is in turn connected to most of the major components of the server. Alternatively, the CPU 180 or, for example, a signal that is asserted by another server on the private connection 80 could be used to actively reset the server by instructing the reset controller to assert the system-reset signal.

Whilst a SAN with large amounts of cache and redundant power supplies ensures that data stored in the network is protected at all times, user-access to the data can be disabled if a server fails. In a SAN context, server clustering is a process whereby servers are grouped together to share data from the storage devices, and wherein each server is available to client workstations. Since various servers have access to a common pool of data, the workstations have a choice of servers through which to access that data. This has the advantage of increasing the fault tolerance of the SAN by providing alternative routes to stored data should a server fail, thereby maintaining uninterrupted data and application availability.

Clusters may be classified as being failover or load-balancing. In a failover cluster a given server may be a hot-spare (or hot-standby) which behaves as a purely passive node in the cluster and only activates when another server fails. Servers in load-balancing clusters may be active at all times in the cluster. Such clusters can produce significant performance gains through the distribution of computational tasks between the servers.

In a shared disk failover cluster, all the servers have access to all the data on any given disk, consequently there needs to be a method of co-ordinating the activities of the connected devices. At a hardware level there needs to be some form of arbitration between the servers for access to a given disk and this is normally dealt with by the network protocols (SCSI etc.). At the software level, since data is normally stored in a SAN as files or records, a locking mechanism is necessary to ensure mutual exclusion of servers as file system metadata is modified, i.e. any operations on file system metadata must be atomic to ensure that they are completed properly. Such locking mechanism is normally provided by a lock manager which keeps a record of which processor has ownership of particular parts of the file system at any given time. The presence of a lock on a given file in the lock manager's records precludes another server from using the file. Such access restrictions continue until the lock is removed from the lock manager's records.

Normally, lock management records are held in a centralised manner in redundant special purpose lock management processors. Alternatively, for a lower performance solution, these can be handled in software as part of a clustered file system (CFS), for example, Global File System (GFS) (see www.sistina.com/gfs).

Referring to FIG. 2, when a given client workstation (60) requires access to data stored in the SAN (10), it transmits a corresponding request on the network (70). In this example the request is transmitted to either Server A (20) or Server B (30) through their respective network adaptors (160). On receipt of the request, the receiving server (for example Server B (30)) under control of its CPU (180), memory (190) and memory controller (200) transmits its own request through its FC/PCI chip (220) onto the FC-AL (40). The request is transmitted to a special purpose lock management processor (240) to search its records for the presence of a lock on the relevant file by another server.

If on searching the records of the lock management processor (240) it is determined that the server is not precluded from accessing the requested file by other servers on the FC-AL (40), the server can proceed to access the relevant data from the appropriate disk (50). The server does this by transmitting a further request on the FC-AL (40) to the appropriate disk (50). The retrieved file is transmitted around the loop to the FC/PCI chip (220) of the server, where it is converted into a form compatible with its PCI connections. The retrieved file is then transmitted to the requesting client workstation (60) through the network (70).

However, if there is already a lock placed on the file by another server on the FCAL (40), the server requesting access to the file is precluded from doing so, and must repeatedly search the lock management processor's records (240) until the server using the file has finished its operations thereon and has removed its lock therefrom. On detecting the removal of the lock the requesting server can initiate its own operations on the file.

The reliance on special purpose redundant lock management processors for maintaining a centralised memory containing all the locks placed on files has a number of disadvantages. Since such processors have a finite capacity they are not scalable with the number of servers in the cluster. The addition of servers to a cluster will increase the number of lock records to be maintained by the lock manager. Consequently the search time for determining whether or not a given file has a lock on it will increase with the number of connected (and hence contributing) data-sharing servers. Such records will eventually fill the processor causing the lock management system to collapse.

Further since the queries to the centralised lock management processors are transmitted along the FC-AL (40) itself, increasing the number of data-sharing servers connected to the FC-AL (40) increases the traffic along the FC-AL (40) beyond that which is already necessary for the transmission of data and/or commands by the servers to FC-AL (40) connected disks. Consequently the use of a centralised lock management processor causes the rate of transmission of data between the disks and the servers to be inversely scalable with the number of connected servers, beyond that which would be expected from the increased data/command traffic that might be contributed by the servers.

A further disadvantage of such prior art methods of lock management is that the use of a centralised store for the lock management records introduces a single point of failure into the SAN, thereby reducing its fault tolerance.

### SUMMARY OF INVENTION

According to the invention there is a provided a lock management apparatus comprising: means for receiving from a processor associated with said lock management apparatus an indicator of a resource to be locked;means for causing a corresponding indicator to be stored; means for causing said stored indicator to be deleted when an associated resource is unlocked;means for receiving from a network a frame indicative of a lock request for a resource; means, responsive to receiving a lock request frame originating from another processor, for checking any stored indicators for a matching locked resource; means, responsive to detecting a match, for transmitting a frame indicative of said resource being locked by said processor to the originator of said lock request; and means, responsive to not detecting a match, for transmitting said lock request frame to the originator of said lock request.

Preferably, said apparatus comprises: means for receiving from said processor associated with said lock management apparatus a provisional indicator of a resource to be locked; and wherein said storing means stores an indicator corresponding to said provisional indicator.

Preferably, said apparatus comprises: means for receiving from said processor associated with said lock management apparatus a check to determine if a resource is locked by said processor; and means for indicating to said associated processor if said resource is locked.

Preferably, the associated processor controls a network server in one of a redundant pair of servers. Further preferably, said apparatus comprises: means for receiving from the network a frame from the other of said pair of redundant servers including an indicator of a resource to be locked; means for causing a corresponding indicator to be stored; and means for causing said stored indicator to be deleted when an associated resource is unlocked.

Preferably, the apparatus may be a separate component of a server motherboard or may be integrated within the server motherboard.

Preferably, said indicators are stored in a content addressable memory (CAM).

Preferably, said network is a fibre channel arbitrated loop (FC-AL).

Further preferably, said transmitting means are adapted to transmit frames to the originator of a lock request via any nodes in said loop between said lock management apparatus and said originator.

Preferably, said originator is another server or alternatively said originator is another lock management apparatus associated with another server.

Further preferably, said CAM is associated with a pair of lock management apparatus according to the invention, each of which is adapted to receive and transmit frames on a respective one of two redundant loops comprising said FC-AL.

In the preferred embodiment, since each server is equipped with its own CAM, adding new servers to the FC-AL increases the effective size of the CAM of the network in an approximately linear manner resulting in scaleable lock management.

Further since the CAM is distributed amongst all the individual servers, there is no longer a single point of failure for the CAM as there would have been in the conventional centralised CAM.

Also since a given server may only to need search as little as its CAM for its own locks instead of the search through all the lock records in a centralised CAM, a performance increase is obtained over conventional software lock management by accelerating the lock management functions.

Overall, using a CAM in each server, rather than relying on a centralized lock management resource, results in fast, redundant, distributed scaleable lock management.

### BRIEF DESCRIPTION OF DRAWINGS

Embodiments of the invention will now be described with reference to the accompanying drawings, in which:

FIG. 1 shows a conventional SAN with private interconnections between its servers;

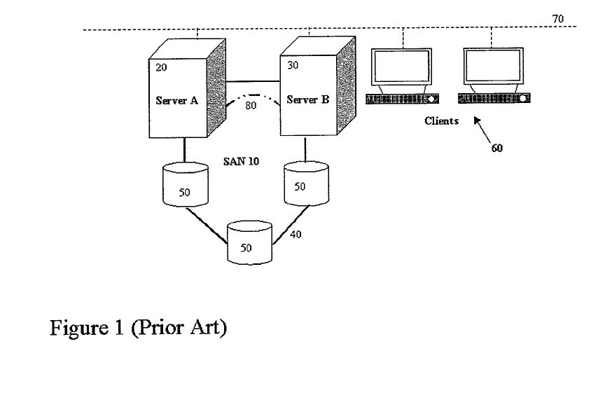

FIG. 2 shows another conventional SAN in which lock management is provided through a central lock manager;

FIG. 3 is a block diagram providing a broad overview of the hardware components of a SAN in which each server has an associated support device (HASC) according to a preferred embodiment of the invention to facilitate server resetting and lock management;

FIG. 4 is a block diagram of the components of a frame processed by the support device of FIG. 3;

FIG. 5 is a more detailed block diagram showing the components and processes occurring in a server of FIG. 3; and

FIG. 6 is a block diagram showing a dual loop embodiment of the invention.

### DETAILED DESCRIPTION

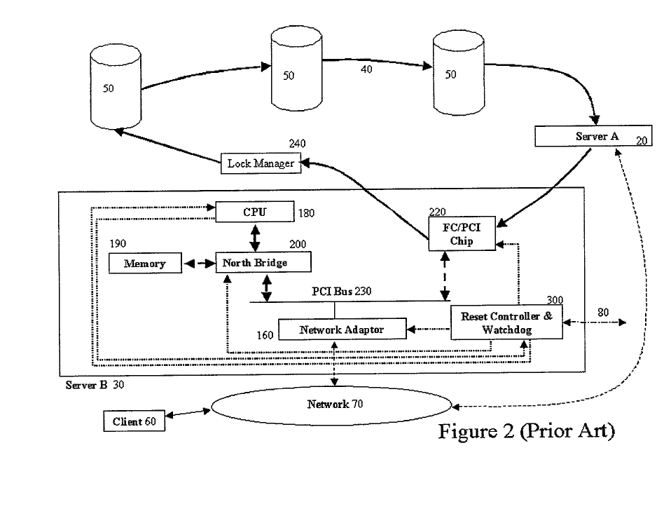

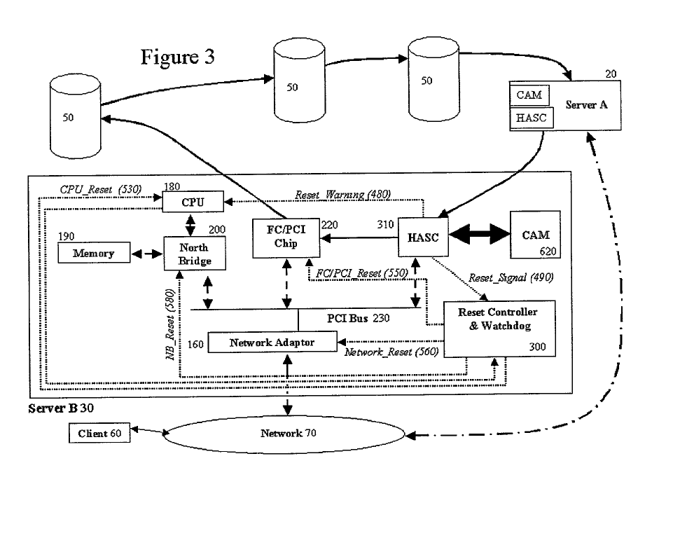

FIG. 3 is a block diagram providing a broad overview of the hardware components of a FC-AL SAN where components with the same numerals as in FIG. 2 perform corresponding functions. The SAN comprises one or more storage shelves holdings disks 50 and a plurality of highly available servers (only two 20, 30 shown). The servers may dedicated PCB format devices housed within a shelf. Such servers could typically include inter alia external expansion ports for extending the fibre channel 40 from shelf to shelf and also an external network connector allowing the server to plug into the network 70. Alternatively, the servers may be stand-alone general-purpose computers.

In any case, each server 20,30 has an associated support device (310) referred to in the description as a HASC (high availability support chip). For a dedicated server, the HASC could be implemented as a chip which plugs into a socket on the server PCB, whereas for a general-purpose server, the HASC could reside on its own card, plugging-into the server system motherboard.

In any case, at system initialisation each high availability server twins with a buddy. If dedicated servers are used, twinned servers should preferably not be located in the same shelf (for added reliability). During normal operation the highly available servers load share and if a server loses its buddy it can buddy up with a spare if available. In the preferred embodiment there may be a requirement for more high availability processors than provided for by the natural limit of such systems. For some systems, approximately 8 shelves would produce a limit of 16 high availability servers. (In other conventional systems, the servers would be in one rack and the storage in either the same rack or another one.) In any case, there are four alternatives to adding processors:

(i) Add extra shelves with no drives;

(ii) Re-package the high-availability server into a format using SCA (Single Connector Attachment) connectors, so that it can be loaded from the front of a backplane, instead of one or more disks;

(iii) Design a custom backplane, capable of taking lots of high-availability servers, in a front loadable format; or

(iv) Design metalwork capable of holding high-availability servers.

In any case, a server's HASC (310) is provided with a FC interface comprising a pair of ports that enable it to connect to the FC-AL (40) and so communicate with any server's via their associated FC/PCI chip (220). The HASC (310) also includes a PCI interface enabling communication with its associated server's CPU (180) through the server's PCI bus (230).

The HASC is further provided with connections to an associated Content Addressable Memory (CAM) (620). On providing the CAM with the data for which it is required that a search be done, the CAM will search itself for the data and if the CAM contains a copy of that data, the CAM will return the address of the data therein. In this embodiment, the HASC allows the CAM to be read and written by the local CPU (180) via the PCI Bus 230 or by any other device on the FC-AL (40), via the FC interface. It will be seen that because, the HASC (310) is ultimately a totally hardware component it permits fast searching of the CAM. (It will nonetheless be seen that the HASC can be designed using software packages, which store the chip design in VHDL format prior to fabrication.)

In the preferred embodiment, the HASC (310) is shown as a separate board from that of the server (30), with its own Arbitrated Loop Physical Addresses (ALPA). However, it should be recognised that the HASC (310) could be incorporated into the server wherein both components would share the same FC-AL interface (220) and ALPA, such incorporation producing the beneficial effect of reducing the latency caused by the provision of HASC support services.

In this example, data from Server A (20) is transmitted through the FC-AL (40) to Server B (30). Before it is transmitted on an FC-AL, every byte of data is encoded into a 10 bit string known as a transmission character (using an 8B/10B encoding technique (U.S. Pat. No. 4,486,739)). Each un-encoded byte is accompanied by a control variable of value D or K, designating the status of the rest of the bytes in the transmission character as that of a data character or a special character respectively. In general, the purpose of this encoding process is to ensure that there are sufficient transitions in the serial bit-stream to make clock recovery possible.

All information in FC is transmitted in groups of four transmission characters called transmission words (40 bits). Some transmission words have a K28.5 transmission character as their first transmission character and are called ordered sets. Ordered sets provide a synchronisation facility which complements the synchronisation facility provided by the 8B/ 10B encoding technique.

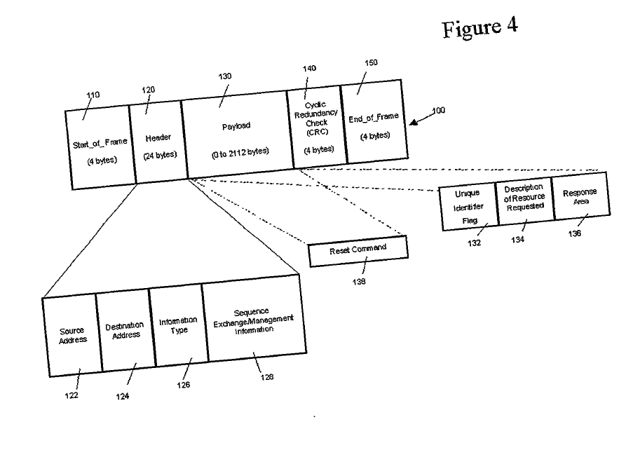

Frame delimiters are one class of ordered set. A frame delimiter includes one of a Start_of_Frame (SOF) or an End_of_Frame (EOF). These ordered sets immediately precede or follow the contents of a frame, their purpose being to mark the beginning and end of frames which are the smallest indivisible packet of information transmitted between two devices connected to a FC-AL, FIG. 4.

As well as a Start_of_Frame (SOF) ordered set (110) and an End_of_Frame (EOF) ordered set (150), each frame (100) comprises a header (120), a payload (130), and a Cyclic Redundancy Check (CRC) (140). The header (120) contains information about the frame, including:

routing information (the addresses of the source and destination devices (122 and 124) known as the source and destination ALPA respectively)

the type of information contained in the payload (126)

and sequence exchange/management information (128).

The payload (130) contains the actual data to be transmitted and can be of variable length between the limits of 0 and 2112 bytes. The CRC (140) is a 4-byte record used for detecting bit errors in the frame when received.

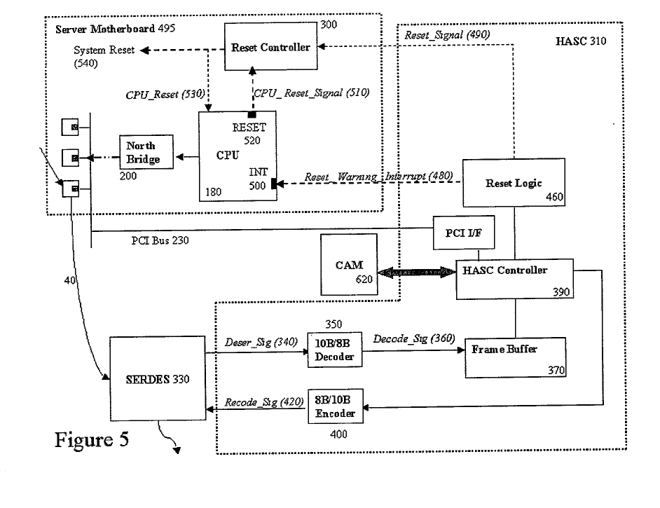

FIG. 5 shows the processes occurring in Server B (30) on receipt of a frame from Server A (20) in more detail. The frame is transmitted to a Serialiser/Deserialiser (SERDES) (330) that samples and retimes the signal according to an internal clock that is phase-locked to the received serial data (further details can be obtained from Vitesse Data Sheet VSC7126).

The SERDES (330) deserialises the data into parallel data at 1/10^{th} or 1/20^{th} of the rate of the serial data and transmits the resulting data onto the 10-bit or 20-bit bus (Deser_Sig (340)). In the embodiment shown in FIG. 5 the SERDES (330) is shown as an external component, independent of the HASC (310) itself, but it should be recognised that it could equally be an integral component of the HASC (310).

The deserialised data (Deser_Sig(340)) is decoded by a block of 10B/8B decoders (350) in accordance with the inverse of the 8B/10B encoding scheme to convert the received 10 bit transmission characters into bytes (Decode_Sig (360)). In the embodiment depicted in FIG. 5, the 10B/8B decoder block (350) is shown as an internal component of the HASC (310) but it should be recognised that the decoding could have been performed in the SERDES (330) itself.

The unencoded data (Decode_sig (360)) is transmitted along an 8 bit bus to a frame buffer (370) which identifies from the unencoded data-stream, frames (100) transmitted between different devices connected to the FC-AL (40) and transmits the frames to the HASC controller (390).

In one aspect of the preferred embodiment, the HASC is employed to provide predictable reset operation and overcome the problem of resetting servers through the FC_AL. Using an associated HASC (310), one processor can interrogate and control the reset signals of another server, thus forcing it off the fibre channel loop if necessary. In this case, the payload (130) of a frame responsible for resetting a server includes a reset command (138), FIG. 4.

In another aspect of the embodiment, the payload (130) of a frame responsible for lock management is further divided into a unique identifier flag (132), a description of the resource requested (134) and a response area (136). In this case, the unique identifier flag (132) indicates that the frame (100) contains a lock request and thereby serves to differentiate the frame (100) from the rest of the traffic on the FC-AL (40). The description of the resource requested (134) section holds the name of the file (or block ID) for which the presence of locks is being searched. The response area (136) section of the payload (130) is where a server with a lock on the file listed in the description of resource requested (134) writes a message to indicate the same.

The HASC controller (390) checks the payload of a received frame for the presence of a reset command (138) or a lock management unique identifier flag (132). The HASC controller (390) further extracts from the frame header (120), the Arbitrated Loop Physical Addresses (ALPA) of the source and destination devices of the received frame (122, 124).

Reset Frames: A frame is identified as being a reset frame (i.e. for the purpose of resetting a server) if its payload (130) contains a reset command (138).

In this example, if the ALPA of the destination device of a reset frame (124), detected by the HASC controller (390) of Server B (30), does not match the ALPA of the HASC (310), it indicates that the frame has been sent from Server A (20) to reset a server other than Server B (30). In such case, the frame (100) is transmitted to an 8B/10B encoding block (400) which re-encodes every 8 bits of the data into 10 bit transmission characters (Recode_sig (420)). The resulting data is serialised by the SERDES (330) and transmitted it to the next device on the FC-AL (60).

However, if the ALPA of the destination device of a reset frame (124) does match the ALPA of the HASC (310) of server B (30), it indicates that Server A (20) has sent the frame with the intention of resetting Server B (30). In this case, the frame's reset command (138) activates a reset logic unit (460) of the HASC (310).

The reset logic unit (460) subsequently produces two signals, namely Reset_Warning (480) and Reset_Signal (490) which are both transmitted to the server's motherboard (495).

The Reset_Warning signal (480) is transmitted to an interrupt input (500) of the server CPU (180) and warns the server (30) that it is about to be reset so that it can gracefully shut-down any applications it might be running at the time. Once the server's applications are shut-down, the server's CPU (180) transmits its own CPU_Reset_Signal (510) from its reset output (520) to the server's reset controller (300) in order to activate the reset process.

Alternatively if it is necessary to shutdown the hung server immediately, a Reset_Signal (490) is sent directly from the reset logic unit (460) of the HASC (310) to the server reset controller (300). The reset controller (300) then sends a reset signal to the CPU ( CPU_Reset (530)) and issues system resets (540).

The system resets (540) are shown more clearly in FIG. 3 which shows the relationships between the HASC (310) and the rest of the server (30) and SAN (10) components. The system resets (540) comprise an FC/PCI_Reset (550) to the FC/PCI chip (220), a Network_Link_Reset (560) to the network adaptor (160) and a NB Reset (580) to the North Bridge (200).

The reset procedure operates in two modes, namely reset and release and reset and hold. The reset and release mode is typically used in high availability systems and is implemented by transmitting the CPU_Reset (530) and system reset (540) signals for a period and then terminating that transmission (i.e. releasing the reset server to continue functioning as normal). The status of the reset server is monitored by its buddy to determine whether it is functioning properly after the reset operation (i.e. to determine whether the reset operation has remedied the fault in the server).

In the reset and hold mode it is assumed that it is not possible to remedy the error in the faulty server by simply resetting it, or in other words that the server would not function properly after a reset had been terminated. Consequently the transmission of the CPU reset (530) and system resets (540) to the errant server are continued until the server can be replaced.

So far the discussions of fault detection and server resetting by the buddy system have described the situation where only one of the devices in the buddy pair was faulty at a given point in time. However if both servers in the buddy pair were to fail at the same time, there is a risk that the two servers would reset each other simultaneously. In order to prevent such occurrence, one of the servers in a buddy pair is designated the master with a watchdog timeout of shorter duration than that of the other server.

In the embodiment described above the servers engage in load-balancing during normal operation and can buddy up with a spare, if available, if it loses its own buddy. Whilst the embodiment is described with reference to a two server buddy system, it should be recognised that the invention is not limited in respect of the number of servers which can reset each other.

In any case, it will be seen that the HASC can operate in Reset mode without any software configuration or support, and as such is independent of the server logic.

Lock Management Frame A frame is identified as being for the purpose of lock management if its payload (130) contains a lock management unique identifier flag (132).

If the ALPA of the destination device of a lock management frame (124) matches the ALPA of the HASC (310) (of server B (30) in this example), it indicates that Server A (20) (in this example) has sent the frame to check whether or not Server B (30) has a lock on the file identified in the description of resource requested section (134) of its payload (130). In general, however, the originator of a lock management frame would simply send the frame to itself, ensuring that the frame would travel all around the loop. In this regard it should be noted that either the server, via its own FC-AL port can issue the lock management frame, or it can delegate this task to its associated HASC. In the former case, a lock management frame will terminate at the server FC-AL port with the processor then indicating to the HASC if it has obtained a lock or not, while in the latter, the HASC notifies the associated processor if a lock has been obtained or not.

Prior to transmitting the frame, Server A (20) via its HASC (310) first checks its own CAM (620) to determine whether or not it already had a lock on the file by a concurrently running process based on a previous request for the same file from another client workstation (60). If Server A (20) determines that it does already have a lock on the file, the client workstation requesting access to the file will have to wait until the process accessing the file, relinquishes its locks thereon. It is only if Server A (20) determines that it does not already have a lock on the file that it transmits a lock management frame to the other devices on the FC-AL.

The frame transmitted by Server A (20) includes Server A's (20) own ALPA as its frame destination ALPA (124).

When the frame is identified by the HASC controller (390) of Server B (30) as a lock management frame from another server, the HASC controller (390) extracts the filename (or the block ID) from the description of resource requested (134) section of the frame. The HASC controller (390) then transmits the filename (or block ID) to the CAM (620), which causes the CAM (620) to search its records for the presence of the relevant filename (or block ID). The presence of the corresponding file entry in the CAM (620) indicates that Server B (30) has a lock on the file of interest. (As described later, it can also indicate if Server B wants to lock the file of interest.)

The results of the CAM (620) search are transmitted back to the HASC controller (390). If the search results indicate that the server has a lock on the file in question, the HASC controller (390) will make an entry in the response area (136) of the frame's payload (130) to that effect. However if the search results indicate that the server does not have a lock on the file in question, the frame is not amended.

The HASC controller (390) returns the resulting frame to an 8B/10B encoding block (400) for re-encoding and subsequent serialisation by the SERDES (330) as described above. The resulting frame is then transmitted onto the FC-AL (40) to the next device connected thereto. The 8B/10B encoding blocks (400) re-encode every 8 bits of the data into 10 bit transmission characters (Recode_Sig (420)) to be parallelised by the SERDES (330) and transmitted to the next device on the FC-AL (40).

However, if the destination ALPA (124) of the received lock management frame (100) matches the server's own ALPA, this indicates that the frame has done a full circle of the FC-AL (40) and has returned to its originator (Server A (20) in this example) having stimulated each server on the FC-AL (40) in turn to conduct a search of its CAM (620) and to amend the frame accordingly.

If on receiving the frame, the originator of the lock management frame does not find any entries in the response area (136) of the frame (100), then this indicates that the file in question does not have any locks on it by the other servers on the FC-AL (40). In this case, the server accesses the file and the server's HASC controller (390) causes the CAM (620) to write a lock for the file to its own records, thereby preventing other servers on the FC-AL (40) from accessing the file.

Since it is necessary for Server A (20) to query every server on the FC-AL for the presence of a lock before placing its own lock on the file, Server A (20) makes an additional provisional entry to its own CAM before transmitting its lock management frame to prevent any of the other servers on the FC-AL from putting a lock on the file (or in other words, changing its lock status) whilst Server A (20) is querying the rest of the servers on the FC-AL.

This can cause two servers seeking to lock the same file to at the same time provisionally lock the file in their own CAMs before discovering another server has provisionally locked the file. There are many ways to resolve such a scenario, for example, both servers could then release their provisional lock and re-try a random period afterwards to resolve access to the file.

The description of the embodiment has so far focussed on the lock management functionality in isolation. However as has already been stated, the buddy system for identifying and resetting hung servers is particularly important in file-sharing systems since a given server that fails could leave its locks in place indefinitely. However, the process of resetting a faulty server also clears its locks. Hence, it is necessary for each server in a buddy pair to retain a record of its buddy's locks in order to restore its buddy to the condition it had been (in respect of its locks) prior to a reset operation, if the buddy hangs. Consequently, a server's CAM must have sufficient capacity to hold both its own locks and those of its buddy.

When a server is finished using a file it must remove its locks on the file to enable other servers on the FC-AL (40) to access the file. This is achieved by clearing the relevant filename from its CAM (620). But since a server keeps a copy of its buddy's locks it is also necessary for the server wishing to clear a filename from its CAM (620), to do so to the copy of its locks in its buddy's CAM (620). If the CAM (620) has filled with lock records it will not permit further lock management traffic on the FC-AL until some of its locks (or those of its buddy) have cleared.

Further, if a server determines that it has a lock on a file it could additionally append to its tag on the lock management frame, its ALPA and/or, the time at which it had locked the frame. Such data would enable a server to check the activity on a lock and if the lock has remained unchanged over an extended period, inferring that the locking server had hung.

It should also be noted that FC-AL devices support dual loop modes of operation, enhancing fault-tolerance by allowing redundant configurations to be implemented. The dual loop system also offers the potential of increasing throughput of the SAN by sending commands to a device over one loop whilst transferring data over the other loop and this again has importance for file sharing systems.

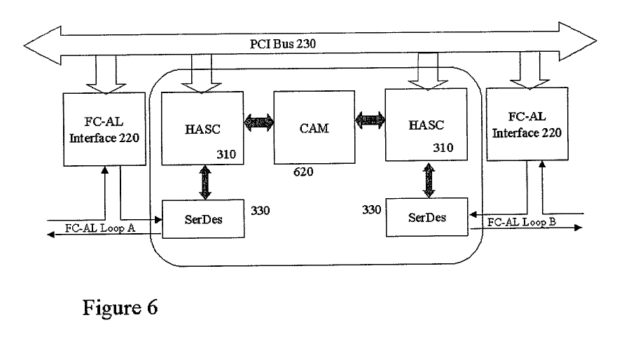

FIG. 6 shows the relevant details of a server supporting such duplex operation so that the server can receive data from either FC-AL loop A and/or FC-AL loop B, wherein each loop could also be connected to different devices. The server has two separate PCI connected HASCs (310) and SERDES (330) for each loop, with each HASC (310) being in communication with a common content addressable memory (CAM) (620) for the purposes of maintaining file locks in the file sharing system. In this case, if the HASC were produced as an integrated unit, it would appear simply as having two FC-AL ports, one for each FC loop.

1. A lock management apparatus comprising:
means for receiving from a processor associated with said lock management apparatus an indicator of a resource to be locked;
means for causing a corresponding indicator to be stored;
means for causing said stored indicator to be deleted when an associated resource is unlocked;
means for receiving from a network a frame indicative of a lock request for a resource;
means, responsive to receiving a lock request frame originating from another processor, for checking any stored indicators for a matching locked resource;
means, responsive to detecting a match, for transmitting a frame indicative of said resource being locked by said processor to the originator of said lock request; and
means, responsive to not detecting a match, for transmitting said lock request frame to the originator of said lock request.

2. The apparatus of claim 1 further comprising:
means for receiving from said processor associated with said lock management apparatus a provisional indicator of a resource to be locked; and
wherein said storing means stores an indicator corresponding to said provisional indicator.

3. The apparatus of claim 1 further comprising:
means for receiving from said processor associated with said lock management apparatus a check to determine if a resource is locked by said processor; and
means for indicating to said associated processor if said resource is locked.

4. The apparatus of claim 1 wherein the associated processor controls a network server in one of a redundant pair of servers.

5. The apparatus of claim 4 further comprising:
means for receiving from the network a frame from the other of said pair of redundant servers including an indicator of a resource to be locked;
means for causing a corresponding indicator to be stored; and
means for causing said stored indicator to be deleted when an associated resource is unlocked.

6. The apparatus as claimed in claim 1 wherein the apparatus comprises one of a separate component of a server motherboard or an integral element of a server motherboard.

7. The apparatus as claimed in claim 1 wherein said indicators are stored in a content addressable memory (CAM).

8. The apparatus as claimed in claim 7 wherein said network is a fibre channel arbitrated loop (FC-AL).

9. The apparatus as claimed in claim 8 wherein said transmitting means are adapted to transmit frames to the originator of a lock request via any nodes in said loop between said lock management apparatus and said originator.

10. The apparatus as claimed in claim 9 wherein said originator is one of another server or another lock management apparatus associated with another server.

11. The apparatus as claimed in claim 10 wherein said CAM is associated with a pair of lock management apparatus, each of which is adapted to receive and transmit frames on a respective one of two redundant loops comprising said FC-AL.

12. A method for managing locks comprising:
receiving from an associated processor an indicator of a resource to be locked;
causing a corresponding indicator to be stored;
causing said stored indicator to be deleted when an associated resource is unlocked;
receiving from a network a frame indicative of a lock request for a resource;
responsive to receiving a lock request frame originating from another processor, checking any stored indicators for a matching locked resource;
responsive to detecting a match, transmitting a frame indicative of said resource being locked by said processor to the originator of said lock request; and
responsive to not detecting a match, transmitting said lock request frame to the originator of said lock request.
